(19) United States
(12) Patent Application Publication
(10) Pub. No.: US 2013/0151313 A1
(43) Pub. Date: Jun. 13, 2013

(54) SALES AND OPERATIONS PLANNING INTERFACE TOOL

(71) Applicant: ACCENTURE GLOBAL SERVICES LIMITED, Dublin (IE)

(72) Inventor: Jonathan SUSSMAN, Fair Lawn, NJ (US)

(73) Assignee: ACCENTURE GLOBAL SERVICES LIMITED, Dublin (IE)

(21) Appl. No.: 13/763,307

(22) Filed: Feb. 8, 2013

Related U.S. Application Data
(63) Continuation of application No. PCT/US2011/047310, filed on Aug. 10, 2011.
(60) Provisional application No. 61/401,359, filed on Aug. 10, 2010.

(51) Int. Cl. G06Q 30/02; G06Q 10/08

(52) U.S. Cl. CPC G06Q 30/0202
USPC 705/7.31

(57) ABSTRACT

A method, in one embodiment, can include establishing a demand hierarchy associated with sales and operations planning data of an organization. Note that any item of the demand hierarchy is not assigned to another hierarchy group. Additionally, the method can include establishing a supply hierarchy associated with the sales and operations planning data of the organization. It is noted that any item of the supply hierarchy is not assigned to another hierarchy group. Furthermore, the method can include utilizing one of the demand hierarchy and the supply hierarchy to generate a metric based at an item level. The metric can be output as part of a graphical user interface.

### CROSS REFERENCE TO RELATED APPLICATION

This application is a continuation of International Application No. PCT/US2011/047310, with an international filing date of Aug. 10, 2011, entitled “Sales and Operations Planning Interface Tool,” by Jonathan Sussman, which claims the benefit of U.S. Provisional Patent Application No. 61/401,359, filed Aug. 10, 2010, entitled “Sales and Operations Planning Interface Tool,” by Jonathan Sussman, which are hereby incorporated by reference.

### BACKGROUND

Large organizations such as large businesses or governments typically deal with a wide variety of both customers and suppliers. For example, a large business with thousands of employees may sell hundreds of different products to other businesses (both small and large) and to the general public. The large business wants to satisfy these customers. In addition, the large business may receive an extensive assortment of goods from both small and large businesses, which may be located domestically or in foreign counties, thereby complicating receipt of the desired goods. Therefore, it can be challenging and even problematic for the large business to manage all the different moving parts associated with their customers' demands and receipt of goods from suppliers.

### SUMMARY

A method, in one embodiment, can include establishing a demand hierarchy associated with sales and operations planning data of an organization. Note that any item of the demand hierarchy is not assigned to another hierarchy group. Additionally, the method can include establishing a supply hierarchy associated with the sales and operations planning data of the organization. It is noted that any item of the supply hierarchy is not assigned to another hierarchy group. Furthermore, the method can include utilizing one of the demand hierarchy and the supply hierarchy to generate a metric based at an item level. The metric can be output as part of a graphical user interface.

In addition, in one embodiment, the method can further include utilizing one of the demand hierarchy and the supply hierarchy to generate a spreadsheet pivot table. In an embodiment, the metric can include comparing demand over a past (or previous) time period to a forecast of a future time period. Furthermore, in one embodiment, the past time period can be the last 12 months (or the last year or the last 6 months or the like) and the future time period can be the next year (or the next 6 months or the next 3 months or the like). Moreover, in an embodiment, the metric can include a production plan metric that includes workload capacity. In one embodiment, the production plan can further include projecting when a purchase requisition will be awarded. Additionally, in an embodiment, the method can further include utilizing the graphical user interface to select a lower hierarchy level of one of the demand hierarchy and the supply hierarchy. Moreover, in one embodiment, the method can further include: after the graphical user interface is utilized to select a lower hierarchy level, a graphical representation of the metric is output as part of the graphical user interface.

In another embodiment, a computer readable storage medium having stored thereon, computer-executable instructions that when executed by a computing device cause the computing device to perform a method. The method can include establishing a demand hierarchy associated with sales and operations planning data of an organization. It is noted that any item of the demand hierarchy is not assigned to another hierarchy group. In addition, the method can include establishing a supply hierarchy associated with the sales and operations planning data of the organization. It is pointed out that any item of the supply hierarchy is not assigned to another hierarchy group. Furthermore, the method can include utilizing one of the demand hierarchy and the supply hierarchy to generate a spreadsheet pivot table. The spreadsheet pivot table can be output as part of a graphical user interface.

It is noted that in one embodiment, the method can further include utilizing one of the demand hierarchy and the supply hierarchy to generate a metric based at an item level. Additionally, in an embodiment, the metric can include comparing demand over a past time period to a forecast of a future time period. Also, in one embodiment, the past time period is last year and the future time period is next year. Moreover, in an embodiment, the metric can include a production plan metric that can include projecting when a purchase requisition will be awarded. In one embodiment, the metric can include a production plan metric that includes workload capacity. In addition, in an embodiment, the method can further include utilizing the graphical user interface to select a lower hierarchy level of one of the demand hierarchy and the supply hierarchy. Furthermore, in an embodiment, the method can further include: after the graphical user interface is utilized to select a lower hierarchy level, a graphical representation of the spreadsheet pivot table is output as part of the graphical user interface.

In yet another embodiment, a method can include establishing a demand hierarchy associated with sales and operations planning data of an organization. The demand hierarchy can be set at an item level and any item of the demand hierarchy is not assigned to another hierarchy group. Furthermore, the method can include establishing a supply hierarchy associated with the sales and operations planning data of the organization. Note that the supply hierarchy can be set at an item level and any item of the supply hierarchy is not assigned to another hierarchy group. Additionally, the method can include utilizing one of the demand hierarchy and the supply hierarchy to generate a metric based at an item level. A graphical representation of the metric is output as part of a graphical user interface.

It is pointed out that in an embodiment, the method can further include utilizing one of the demand hierarchy and the supply hierarchy to generate a spreadsheet pivot table. Furthermore, in one embodiment, the metric can include comparing demand over a past time period (e.g., past year, past 12 months, and the like) to a forecast of a future time period (e.g., next year, next 12 months, and the like). In an embodiment, the metric can include a production plan metric that includes workload capacity. It is noted that in one embodiment, the metric can include a production plan metric that can include projecting when a purchase requisition will be awarded. In addition, in an embodiment, the method can further include utilizing the graphical user interface to select a lower hierarchy level of one of the demand hierarchy and the supply hierarchy. Additionally, in one embodiment, the method can further include: after the graphical user interface is utilized to select a lower hierarchy level, a graphical representation of the metric is output as part of the graphical user interface.

While particular embodiments in accordance with the invention have been specifically described within this Summary, it is noted that the invention and the claimed subject matter are not limited in any way by these embodiments.

### BRIEF DESCRIPTION OF THE DRAWINGS

The accompanying drawings, which are incorporated in and form a part of this specification and in which like numerals depict like elements, are included to illustrate principles of the present embodiments and are not intended to limit the invention to the particular implementations illustrated therein.

FIG. 1 shows an exemplary flow diagram of a method in accordance with various embodiments of the invention.

FIG. 2 shows an exemplary block diagram of a sales and operations planning (S&OP) user interface tool in accordance with various embodiments of the invention.

FIG. 3 shows an exemplary block diagram illustrating a demand hierarchy and a supply hierarchy in accordance with various embodiments of the invention.

FIG. 4 shows another exemplary view of the S&OP user interface tool in accordance with various embodiments of the invention.

FIG. 5 shows yet another exemplary view of the S&OP user interface tool in accordance with various embodiments of the invention.

FIG. 6 shows still another exemplary view of the S&OP user interface tool in accordance with various embodiments of the invention.

FIG. 7 shows another exemplary view of the S&OP user interface tool in accordance with various embodiments of the invention.

FIG. 8 shows yet another exemplary view of the S&OP user interface tool in accordance with various embodiments of the invention.

FIG. 9 shows still another exemplary view of the S&OP user interface tool in accordance with various embodiments of the invention.

FIG. 10 shows an exemplary flow diagram of still another method in accordance with various embodiments of the invention.

### DETAILED DESCRIPTION

Reference will now be made in detail to various embodiments in accordance with the invention, examples of which are illustrated in the accompanying drawings. While the invention will be described in conjunction with various embodiments, it will be understood that these various embodiments are not intended to limit the invention. On the contrary, the invention is intended to cover alternatives, modifications and equivalents, which may be included within the scope of the invention as construed according to the Claims. Furthermore, in the following detailed description of various embodiments in accordance with the invention, numerous specific details are set forth in order to provide a thorough understanding of the invention. However, it will be evident to one of ordinary skill in the art that the invention may be practiced without these specific details. In other instances, well known methods, procedures, components, and circuits have not been described in detail as not to unnecessarily obscure aspects of the invention.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of operations or steps or instructions leading to a desired result. The operations or steps are those utilizing physical manipulations of physical quantities. Usually, although not necessarily, these quantities can take the form of electrical or magnetic signals capable of being stored, transferred, combined, compared, and otherwise manipulated in a computer system or computing device. It has proven convenient at times, principally for reasons of common usage, to refer to these signals as transactions, bits, values, elements, symbols, characters, samples, pixels, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “establishing”, “generating”, “utilizing”, “outputting”, “comparing”, “projecting”, “selecting”, “performing”, aggregating”, “receiving”, “gathering”, “retrieving”, “incorporating”, “producing”, “enabling”, “sending”, “determining”, “accessing”, “allowing”, “updating”, or the like, can refer to actions and processes of a computer system or similar electronic computing device or processor. The computer system or similar electronic computing device can manipulate and transform data represented as physical (electronic) quantities within the computer system memories, registers or other such information storage, transmission or display devices.

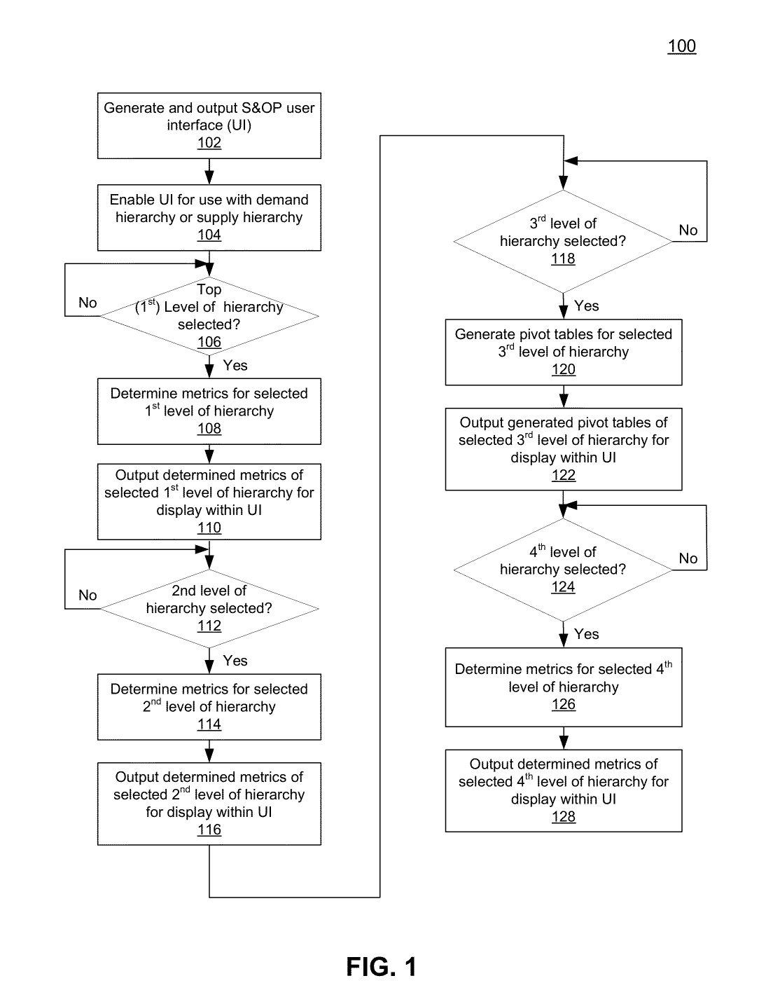

FIG. 1 shows an exemplary flow diagram of a method 100 in accordance with various embodiments of the invention for generating and operating a sales and operations planning (S&OP) user interface tool. Although specific operations are disclosed in flow diagram 100, such operations are examples. Method 100 may not include all of the operations illustrated by FIG. 1. Also, method 100 may include various other operations and/or variations of the operations shown by FIG. 1. Likewise, the sequence of the operations of flow diagram 100 can be modified. It is appreciated that not all of the operations in flow diagram 100 may be performed. In various embodiments, one or more of the operations of method 100 can be performed by software, by firmware, by hardware or by any combination thereof, but is not limited to such. Method 100 can include processes of embodiments of the invention which can be carried out by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium.

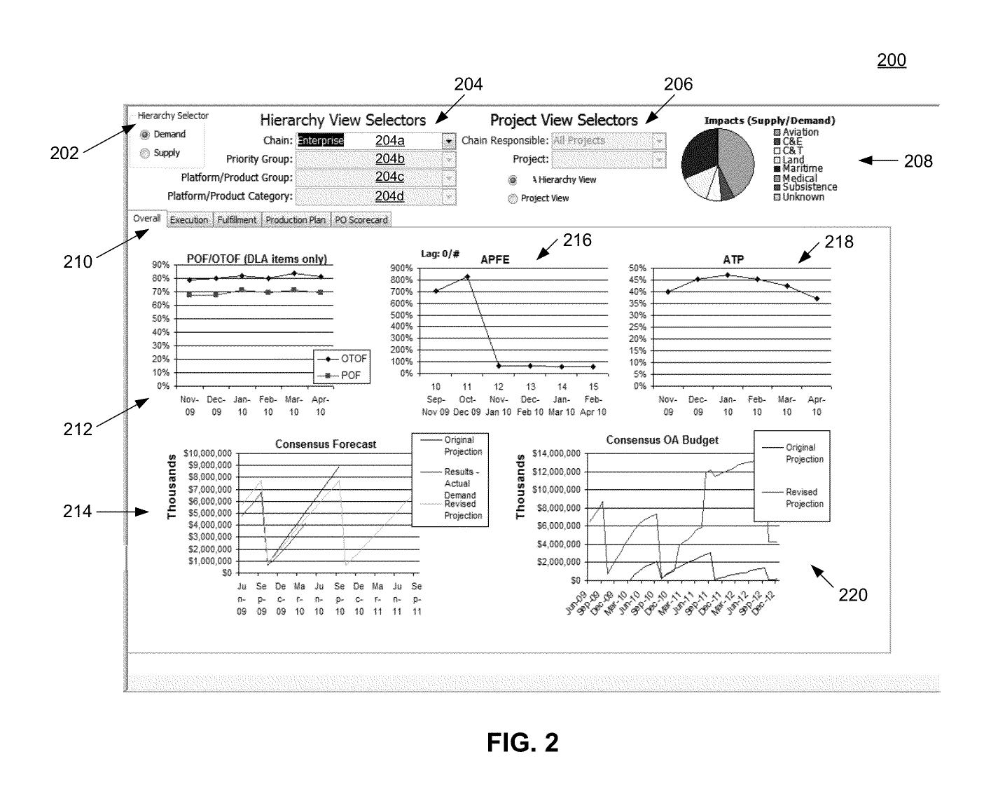

It is pointed out that in one embodiment, sales and operations planning within a business or government organization can provide a framework for customer and supplier operations to come together to decide the best way to use limited resources to meet organizational objectives. For example, tradeoffs and prioritizations can occur to allow agency objectives to be met. In one embodiment, the process of achieving consensus is enabled by an S&OP user interface tool (e.g., 200 of FIG. 2). The S&OP user interface tool 200 can help identify drivers (or forces or motivators) of key metrics and how to improve them.

More specifically, within a business or government organization, it is noted that sales and operations planning can be a single process to engage all functions in creating aligned, forward looking plans, make decisions that will optimize resources, and achieve a balanced set of goals. Sales and operations planning can include, but is not limited to, demand planning, inventory planning, supply planning, and financial planning. In an embodiment, the demand side can include, but is not limited to, sales and marketing teams of the business or government organization along with downstream channel partners. Additionally, the supply side can include, but is not limited to, production, logistics, and the like along with upstream suppliers.

In various embodiments, the sales and operations planning interface tool can generate and/or aggregate customers (or demand) metrics or suppliers (or vendors or supply) metrics based on different hierarchies designed to foster internal and external collaboration thereby enabling better fulfillment strategies. For example in one embodiment, the sales and operations planning interface tool can automatically create high level and detailed metrics along with forward-looking metrics. Furthermore, the sales and operations planning interface tool can automatically generate spreadsheet pivot tables based on the hierarchy thereby allowing for root cause analysis. These concepts will be discussed in more detail hereafter.

At operation 102 of FIG. 1, a sales and operations planning (S&OP) user interface tool can be generated and output for subsequent display by a display device. It is noted that operation 102 can be implemented in a wide variety of ways. FIG. 2 shows an exemplary block diagram of a sales and operations planning (S&OP) user interface tool 200 in accordance with various embodiments of the invention. In one embodiment, the S&OP user interface tool 200 may be implemented as a graphical user interface (GUI). Furthermore, the S&OP user interface tool 200 may have access to one or more databases of supply information and demand information associated with one or more organizations. Moreover, the S&OP user interface tool 200 may organize the supply information into a supply hierarchy and the demand information into a demand hierarchy. It is pointed out that the supply hierarchy and the demand hierarchy can be implemented in a wide variety of ways.

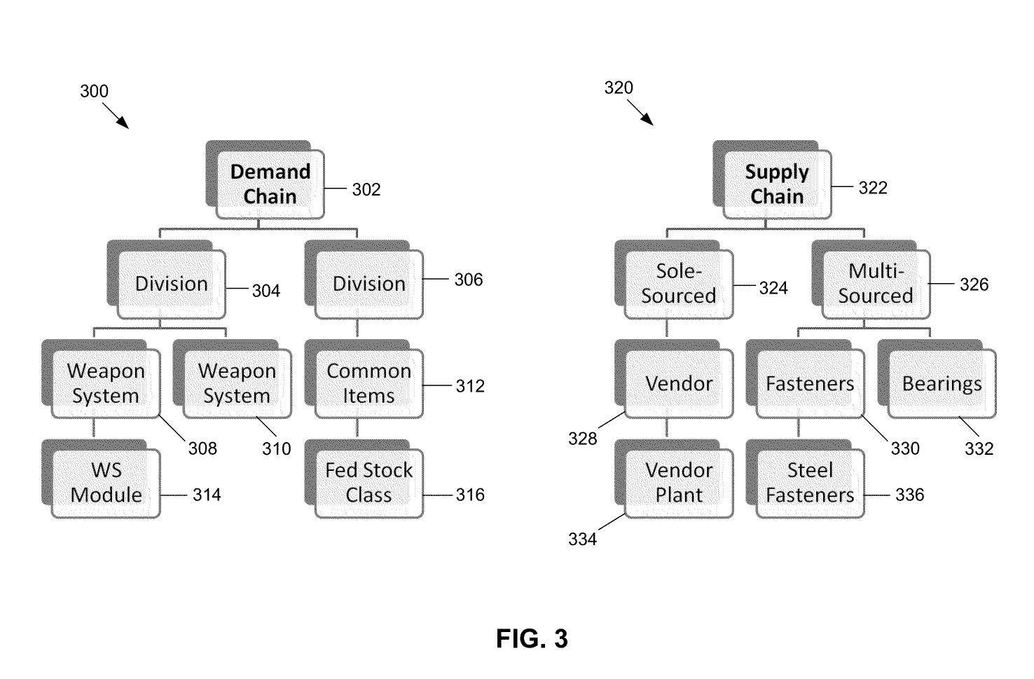

For example, FIG. 3 shows an exemplary block diagram illustrating an exemplary customer (or demand) hierarchy 300 and an exemplary supplier (or supply) hierarchy 320 in accordance with various embodiments of the invention. It is noted that each hierarchy may be based on whatever is important to the business or government organization with regard to its customers or suppliers. For example, a business could use weapon systems and weapon system subgroups to define its customer hierarchy while using supply divisions (e.g., logical item groupings—bearings, fasteners, etc) and subdivisions to define its supplier hierarchy. In this manner, the S&OP user interface tool 200 may organization and use data associated with the customers and suppliers of the business or government organization. Note that in one embodiment, the customer and supplier hierarchies may be implemented to have the same or different number of tiers. Within FIG. 3, the customer (or demand) hierarchy 300 may include a top or first tier (e.g., demand chain) 302. The second tier of the demand hierarchy 300 may include two different divisions 304 and 306. The third tier of the demand hierarchy 300 may include two different weapon system 308 and 310 that are associated with division 304. In addition, the third tier of the demand hierarchy 300 may include “common items” 312 that are associated with the division 306. The fourth tier of the demand hierarchy 300 may include weapon system module items 314 which are associated with weapon system 308. Furthermore, the fourth tier of the demand hierarchy 300 may include federal stock class items 316 that are associated with the common items 312. In one embodiment, individual items may be defined in the lowest tier of the hierarchy. For example in an embodiment, the weapon system module items 314 are part of or are incorporated within weapon system 308, which is one of the weapons systems of division 304.

The supplier hierarchy 320 may include a top or first tier (e.g., supply chain) 322. The second tier of the supply hierarchy 320 may include two different definitions of sources of items (e.g., sole-sourced group 324 and multi-sourced group 326). The third tier of the supply hierarchy 320 may include a vendor 328 associated with the sole-sourced group 324. Additionally, the third tier of the supply hierarchy 320 may include fasteners group 330 and bearings group associated with the multi-sourced group 326. The fourth tier of the supply hierarchy 320 may include vendor plant items 334 that are associated with the vendor 328 and steel fasteners items 336 associated with the fasteners group 3306.

Note that in one embodiment, the demand hierarchy 300 and the supply hierarchy 320 may each be set at the item level thereby making each very flexible. It is pointed out that in an embodiment, items located in the lowest tier of the demand hierarchy 300 and the supply hierarchy 320 cannot be assigned to more than one hierarchy. For example, since the steel fasteners items 336 are assigned to the supply hierarchy 320, they cannot also be assigned to the demand hierarchy 300. By implementing the hierarchies in this manner, it enables metric generation and/or aggregation. In addition, goal setting at the upper level of the business or government organization (e.g., enterprise or chain level) may be pushed down to the tactical level. Furthermore, by not assigning items of the demand hierarchy 300 and the supply hierarchy 320 to more than one hierarchy group, it enables consistent metrics and also enables a framework for internal and external collaboration. Moreover, a demand/supply crosswalk is produced in the pivot tables generated by the S&OP user interface tool 200. Note that in one embodiment, the pivot tables are generated by the S&OP user interface tool 200 at hierarchy level three, but is not limited to such.

Note that the S&OP user interface tool 200 of FIG. 2 may include, but is not limited to, a hierarchy selector 202, hierarchy view selectors 204, project view selectors 206, impacts pie chart 208, and an “overall” tab 210, which when selected results in a view of one or more graphical representations of metrics 212, 214, 216, 218, and 220. It is noted that the different components of the S&OP planning user interface tool 200 will be discussed in combination with method 100 of FIG. 1.

It is pointed out that sales and operations planning within a business or government organization may provide a framework for customer and supplier operations to come together to decide the best way to use limited resources to meet organizational objectives. For example, tradeoffs and prioritizations may occur to allow agency objectives to be met. In one embodiment, the process of achieving consensus is enabled by the S&OP user interface tool 200 of FIG. 2. The S&OP user interface tool 200 may help identify drivers (or forces or motivators) of key metrics and how to improve them.

More specifically, within a business or government organization, it is noted that sales and operations planning may be a single process to engage all functions in creating aligned, forward looking plans, make decisions that will optimize resources, and achieve a balanced set of goals. Sales and operations planning may include, but is not limited to, demand planning, inventory planning, supply planning, and financial planning. In an embodiment, the demand side may include, but is not limited to, sales and marketing teams of the business or government organization along with downstream channel partners. Additionally, the supply side may include, but is not limited to, production, logistics, and the like along with upstream suppliers.

In one embodiment, demand consensus is the way customer operations achieve the best possible forecast. The S&OP user interface tool 200 of FIG. 2 may validate differences between the next 12 months of forecast with the last 12 months of demand. In addition, the S&OP user interface tool 200 may determine how well a forecast performed in the past (e.g., using an Absolute Percent Forecast Error (APFE)) and it may also determine if demand is coming in as excepted at the beginning of the fiscal year (fiscal year demand consensus). The S&OP user interface tool 200 may be utilized to understand demand side drivers. For example, the S&OP user interface tool 200 may be utilized to understand which demand side platforms are consuming purchase requisition awards, organizational funds, and supplier capacity. Specifically, in order to do this, the S&OP user interface tool 200 may use platform performance data to determine how well a platform is performing by determining how well a forecast performed in the past (e.g., using an Absolute Percent Forecast Error (APFE)) together with ratio reports. In addition, the production plan may provide data to the S&OP user interface tool 200, such as, purchase requisition awards and the organizational fund consumption.

In addition, in an embodiment, supply consensus is the process for weighing customer needs against internal and external supply constraints. Note that the forecasts may be balanced with, but are not limited to, purchase requisition capacity, organizational fund guidelines, and supplier capacity. The S&OP user interface tool 200 is able to organize data and metrics too for this balancing to occur. Some of the data may be production plan data, such as, using past award rates, the production plan projects when open, blocked, and soon to be generated purchase requisitions to be awarded. The S&OP user interface tool 200 may be utilized to understand internal and external supply constraints. For example, the S&OP user interface tool 200 may include a list of current and projected purchase requisitions and when they will likely be awarded (production plan), current and projected organizational fund consumption rate, and supplier's responsiveness and/or capacity. The S&OP user interface tool 200 may aid in understanding the aggregate supply base. For example, the S&OP user interface tool 200 may leverage expertise information to aid in understanding current industry capacity and capabilities in context of the production plan.

In one embodiment, the S&OP user interface tool 200 may include project view selectors 206. The project view selectors 206 may be utilized to track one or more projects that may be implemented to correct or improve the performance of one or more components of a hierarchy. Once the correction or improvement has been reached, the one or more projects may be removed or deleted from the S&OP user interface tool 200. It is pointed out that operation 102 may be implemented in any manner similar to that described herein, but is not limited to such.

At operation 104, the sales and operations planning user interface tool (e.g., 200) may be implemented so that it may be utilized with either a demand hierarchy or a supply hierarchy. Note that operation 104 may be implemented in a wide variety of ways. For example in one embodiment, when the S&OP user interface tool 200 is implemented it may include, but is not limited to, a hierarchy selector 202 which enables a user to select whether to use the S&OP user interface tool 200 with a demand hierarchy or a supply hierarchy. Operation 104 may be implemented in any manner similar to that described herein, but is not limited to such.

At operation 106 of FIG. 1, a determination may be made as to whether a top or first tier of a hierarchy has been selected (e.g., 204a) within the sales and operations planning user interface tool (e.g., 200). If not, the method 100 may proceed to repeat operation 106. However, if it is determined at operation 106 that a top or first tier of a hierarchy was selected within the sales and operations planning user interface tool, method 100 may proceed to operation 108. It is pointed out that operation 106 may be implemented in a wide variety of ways. For example in one embodiment, the S&OP user interface tool 200 may be implemented with a drop-down menu 204a which may be utilized by a user to select a particular top or first tier of a hierarchy from one or more available first tier hierarchies of the S&OP user interface tool 200. Within the present embodiment of FIG. 2, the drop-down menu 204a has been utilized to select the “Enterprise” top or first tier hierarchy. Operation 106 may be implemented in any manner similar to that described herein, but is not limited to such.

At operation 108, one or more metrics may automatically be determined or aggregated corresponding to the selected first tier hierarchy (e.g., 204a). It is noted that operation 108 may be implemented in a wide variety of ways. For example in an embodiment, the S&OP user interface tool 200 may be implemented to automatically determine or aggregate one or more metrics corresponding to the selected Enterprise first tier hierarchy of 204a.

For instance, the one or more metrics at operation 108 of FIG. 1 may include, but are not limited to, a consensus forecast, a consensus organization fund budget, an Attainment to Plan (ATP), an Absolute Percent Forecast Error (APFE), and POF/OTOF. In addition, the one or more metrics at operation 108 may include, but are not limited to, total overhead (OH) inventory, Percent Forecast Error (PFE), demand consensus, demand ratio, DPA, production plan (which may include allocation of purchase requisition capacity), blocked purchase requisitions, Stock Out/Stock Low (SO/SL), over procurements (OPs), current inventory levels, late purchase requisitions (PRs), late purchase orders (POs), demand consensus, open/blocked purchase requisitions, open/blocked purchased orders, and supportability.

More specifically, at operation 108, the Attainment to Plan metric may involve whether an order to the supplier was delivered on time, on quality, and on quantity. In one embodiment, the Attainment to Plan metric may be broken down into categories to highlight root causes (e.g., late purchase requisition award, generation, and delivery). Furthermore, the Absolute Percent Forecast Error (APFE) metric may show the error associated with forecasts. The demand consensus metric compares the last 12 months of demand to the next 12 months of forecasts to highlight potential forecast problems. Also, the over procurements (OPs) metric may involve how many over procurements are being experienced. Note that high over procurements are not necessarily adverse if progress has been made to reduce over forecasting. Moreover, the supportability metric may be implemented such that when a bill of materials is given to the S&OP user interface tool 200, it may calculate support dates and may give customer operations the capability to adjust forecasts to the latest get well date. Additionally, the production plan metric may be implemented to utilize past award rate in order to project when open, blocked, and soon to be generated purchase requisitions will be awarded. This may provide insight into which platforms and item categories are consuming workload capacity. It is noted that operation 108 may be implemented in any manner similar to that described herein, but is not limited to such.

At operation 110 of FIG. 1, the one or more determined or aggregated metrics corresponding to the selected chain hierarchy (e.g., of 204a) may be output for display as part of the sales and operations planning user interface tool (e.g., 200). It is pointed out that operation 110 may be implemented in a wide variety of ways. For example in the present embodiment of FIG. 2, the S&OP user interface tool 200 may include a graphical representation of the following metrics that correspond with the selected “Enterprise” chain hierarchy of 204a: the POF/OTOF metric 212, the consensus forecast 214, the Absolute Percent Forecast Error (APFE) metric 216, the Attainment to Plan (ATP) metric 218, and the consensus OA (Obligation Authority) budget metric 220. Note that these metrics are visible since the Overall tab 210 is currently selected within the S&OP user interface tool 200. However, there are other metrics that are currently not shown by the S&OP user interface tool 200 since their respective tab has not been selected (e.g., by a user).

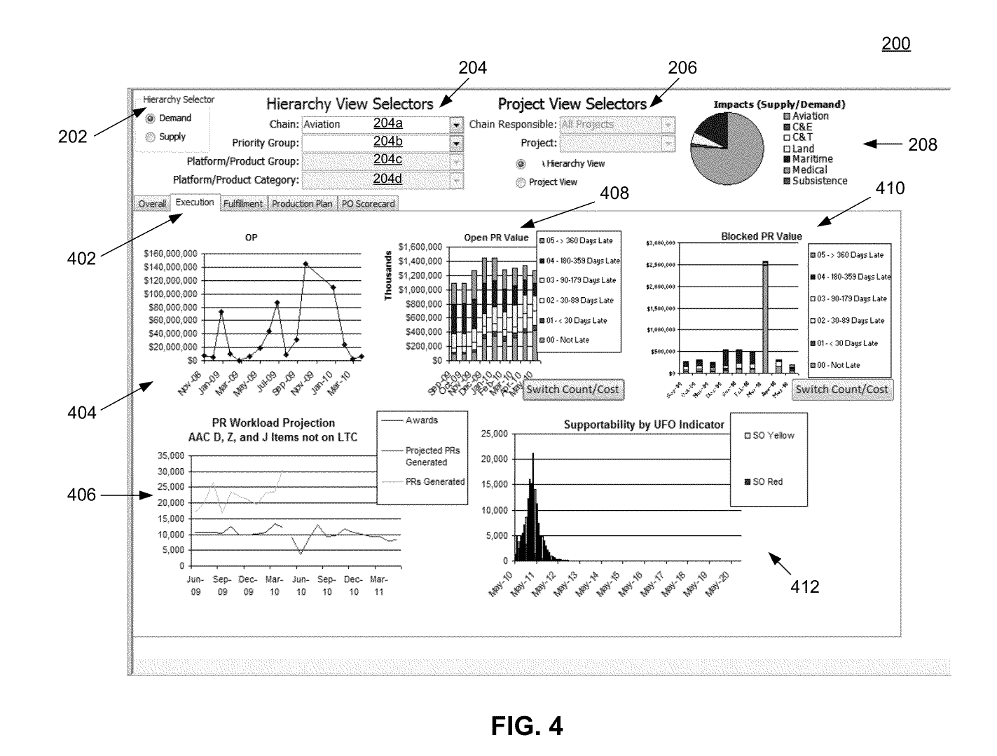

For example, FIG. 4 shows another exemplary view of the S&OP user interface tool 200 in accordance with various embodiments of the invention when an “Execution” tab 402 is selected (e.g., by a user). Note that within FIG. 4, the chain hierarchy has been selected to the “Aviation” chain hierarchy on the drop-down menu 204a. As such, the graphical representations of metrics displayed correspond to the Aviation chain hierarchy of 204a. When the “Execution” tab 402 is selected, the S&OP user interface tool 200 at operation 110 of FIG. 1 may include a graphical representation of the over procurement (OP) metric 404, the open purchase requisition (PR) value metric 408, the blocked purchase requisition (PR) value metric 410, the purchase requisition (PR) workload projection (where the ACC D, Z, and J items are not on LTC) metric 406, and the supportability by Unfilled Order (UFO, also referred to as “back order”) indicator metric 412. It is noted that these metrics are visible since the Execution tab 402 is currently selected within the S&OP user interface tool 200. However, there are other metrics that are currently not shown by the S&OP user interface tool 200 of FIG. 4 since their respective tab has not been selected (e.g., by a user).

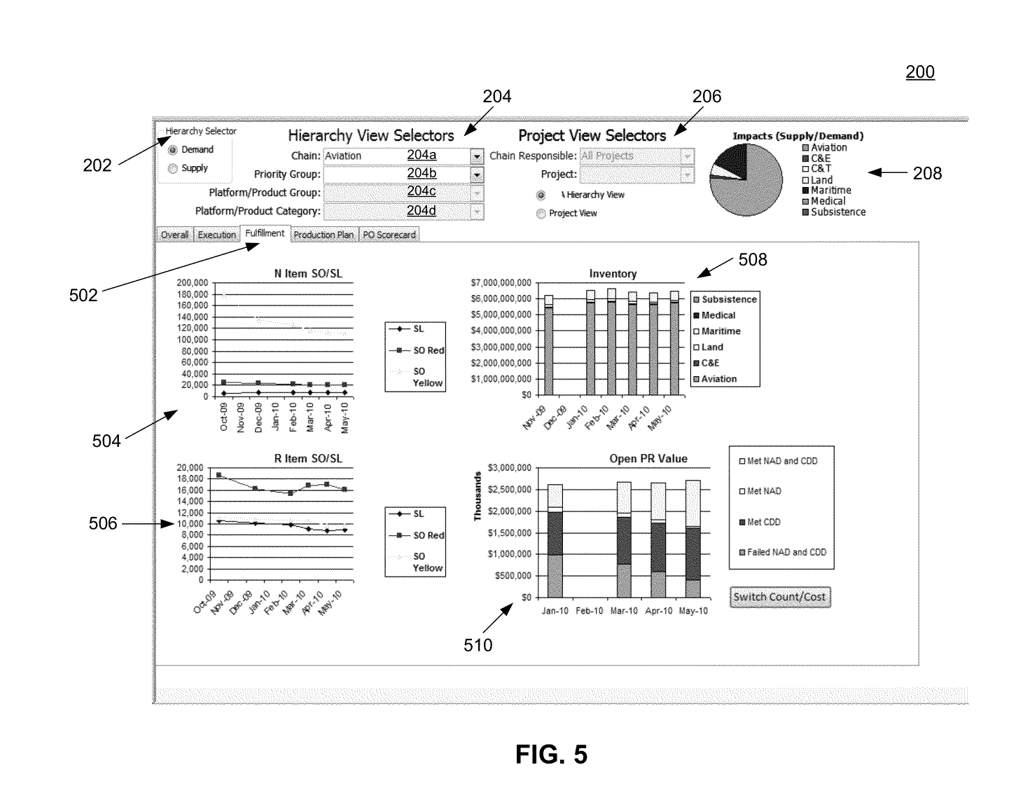

For instance, FIG. 5 shows yet another exemplary view of the S&OP user interface tool 200 in accordance with various embodiments of the invention when an “Fulfillment” tab 502 is selected (e.g., by a user). Note that the chain hierarchy has been selected to the “Aviation” chain hierarchy on the drop-down menu 204a. As such, the graphical representations of metrics displayed correspond to the Aviation chain hierarchy of 204a. When the “Fulfillment” tab 502 is selected, the S&OP user interface tool 200 at operation 110 of FIG. 1 may include a graphical representation of the N item Stock Out/Stock Low (SO/SL) metric 504, the R item Stock Out/Stock Low (SO/SL) metric 506, the inventory metric 508, and the open purchase requisition (PR) value metric 510. Note that these metrics are visible since the Fulfillment tab 502 is currently selected within the S&OP user interface tool 200. However, there are other metrics that are currently not shown by the S&OP user interface tool 200 of FIG. 5 since their respective tab has not been selected (e.g., by a user).

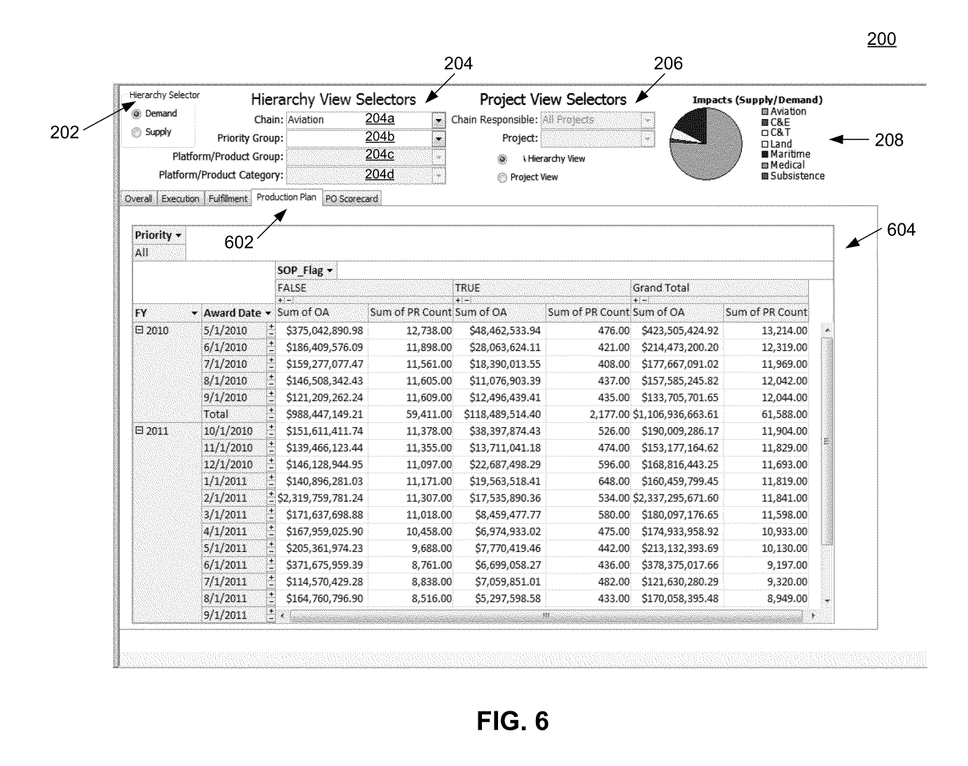

For example, FIG. 6 shows still another exemplary view of the S&OP user interface tool 200 in accordance with various embodiments of the invention when an “Production Plan” tab 602 is selected (e.g., by a user). It is noted that the chain hierarchy has been selected to the “Aviation” chain hierarchy on the drop-down menu 204a. As such, the graphical representations of metrics displayed correspond to the Aviation chain hierarchy of 204a. When the “Production Plan” tab 602 is selected, the S&OP user interface tool 200 at operation 110 of FIG. 1 may include a graphical representation of the production plan metric 604, which in the present embodiment is implemented as a spreadsheet. It is pointed out that this metric is visible since the Production Plan tab 602 is currently selected within the S&OP user interface tool 200. However, there are other metrics that are currently not shown by the S&OP user interface tool 200 of FIG. 6 since their respective tab has not been selected (e.g., by a user).

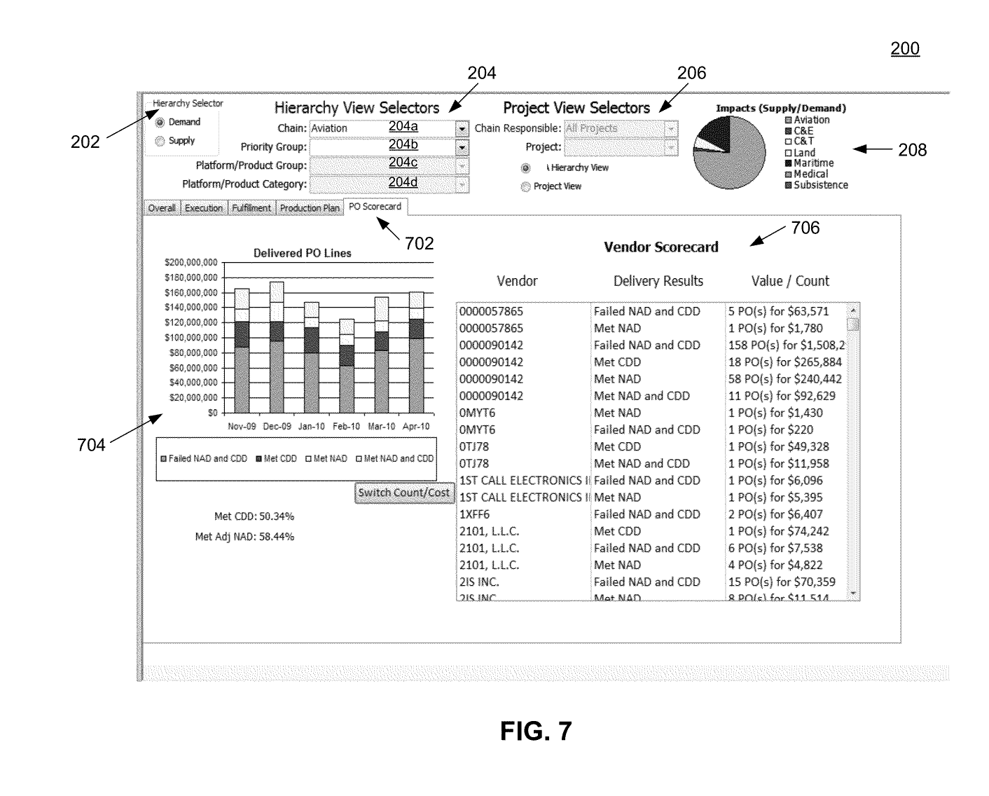

For instance, FIG. 7 shows another exemplary view of the S&OP user interface tool 200 in accordance with various embodiments of the invention when an “PO Scorecard” tab 702 is selected (e.g., by a user). Note that the chain hierarchy has been selected to the “Aviation” chain hierarchy on the drop-down menu 204a. As such, the graphical representations of metrics displayed correspond to the Aviation chain hierarchy of 204a. When the “PO Scorecard” tab 702 is selected, the S&OP user interface tool 200 at operation 110 of FIG. 1 may include a graphical representation of the delivered purchase order (PO) lines metric 704 and the vendor scorecard metric 706. It is pointed out that these metrics are visible since the PO Scorecard 702 is currently selected within the S&OP user interface tool 200. However, there are other metrics that are currently not shown by the S&OP user interface tool 200 of FIG. 7 since their respective tab has not been selected (e.g., by a user). For example, the Overall tab 210, the Execution tab 402, the Fulfillment tab 502, and the Production Plan tab 602 are currently not select within the S&OP user interface tool 200. It is noted that operation 110 may be implemented in any manner similar to that described herein, but is not limited to such.

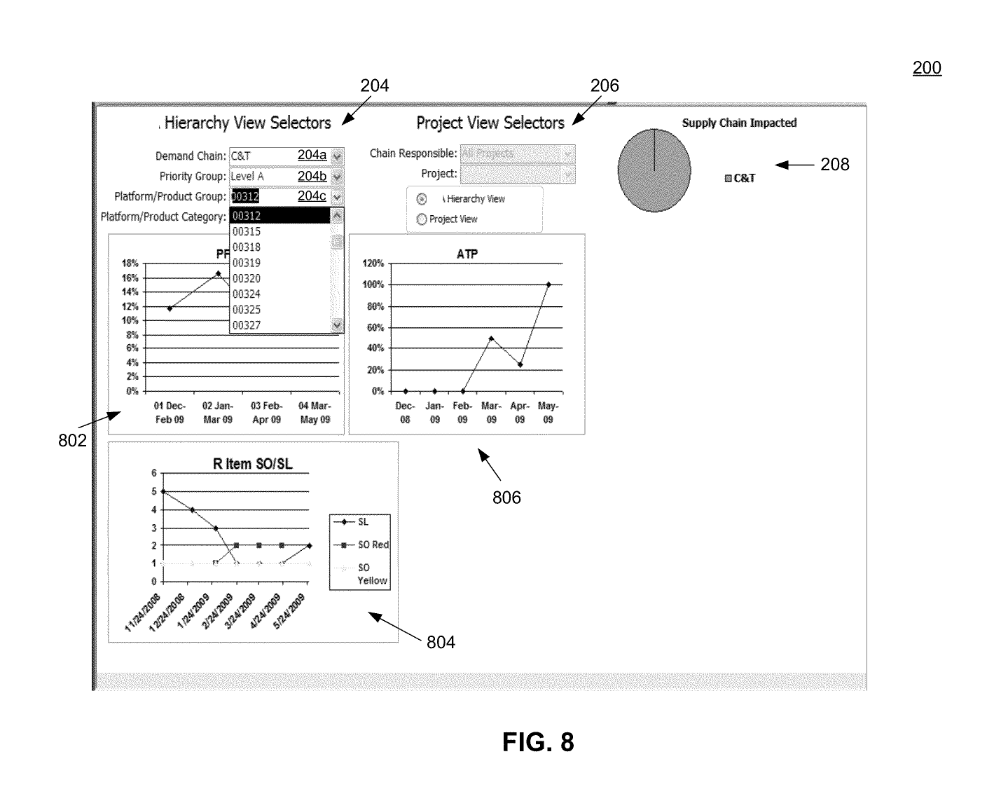

At operation 112 of FIG. 1, a determination may be made as to whether a second level or tier of the hierarchy has been selected (e.g., at 204b) within the sales and operations planning user interface tool (e.g., 200). If not, the method 100 may proceed to repeat operation 112. However, if it is determined at operation 112 that a second level of the hierarchy has been selected within the sales and operations planning user interface tool, the method 100 may proceed to operation 114. FIG. 8 shows yet another exemplary view of the S&OP user interface tool 200 in accordance with various embodiments of the invention. Note that operation 112 may be implemented in a wide variety of ways. For example in an embodiment, the S&OP user interface tool 200 of FIG. 8 may be implemented with a drop-down menu 204b which may be utilized by a user to select a particular second level or tier of the hierarchy (e.g., priority group) from one or more available priority groups of the S&OP user interface tool 200. Within the present embodiment of FIG. 8, the drop-down menu 204b has been utilized to select the “Level A” priority group. Operation 112 may be implemented in any manner similar to that described herein, but is not limited to such.

At operation 114 of FIG. 1, one or more metrics may automatically be determined or aggregated corresponding to the selected tier, for example, priority group tier (e.g., at 204b). It is pointed out that operation 114 may be implemented in a wide variety of ways. For example in one embodiment, the S&OP user interface tool 200 of FIG. 8 may be implemented to automatically determine or aggregate one or more metrics corresponding to the selected “Level A” priority group hierarchy of 204b. For instance, the one or more metrics at operation 114 may include any of the metrics described or mentioned herein, but are not limited to such. Operation 114 may be implemented in any manner similar to that described herein, but is not limited to such.

At operation 116, the one or more determined or aggregated metrics corresponding to the selected priority group (e.g., at 204b) may be output for display as part of the sales and operations planning user interface tool (e.g., 200). For example in the present embodiment of FIG. 8, the S&OP user interface tool 200 may include a graphical representation of the following metrics that correspond with the selected “Level A” priority group of 204b: a Percent Forecast Error (PFE) metric 802, an R item Stock Out/Stock Low (SO/SL) metric 804, and an Attainment to Plan (ATP) metric 806, but is not limited to such.

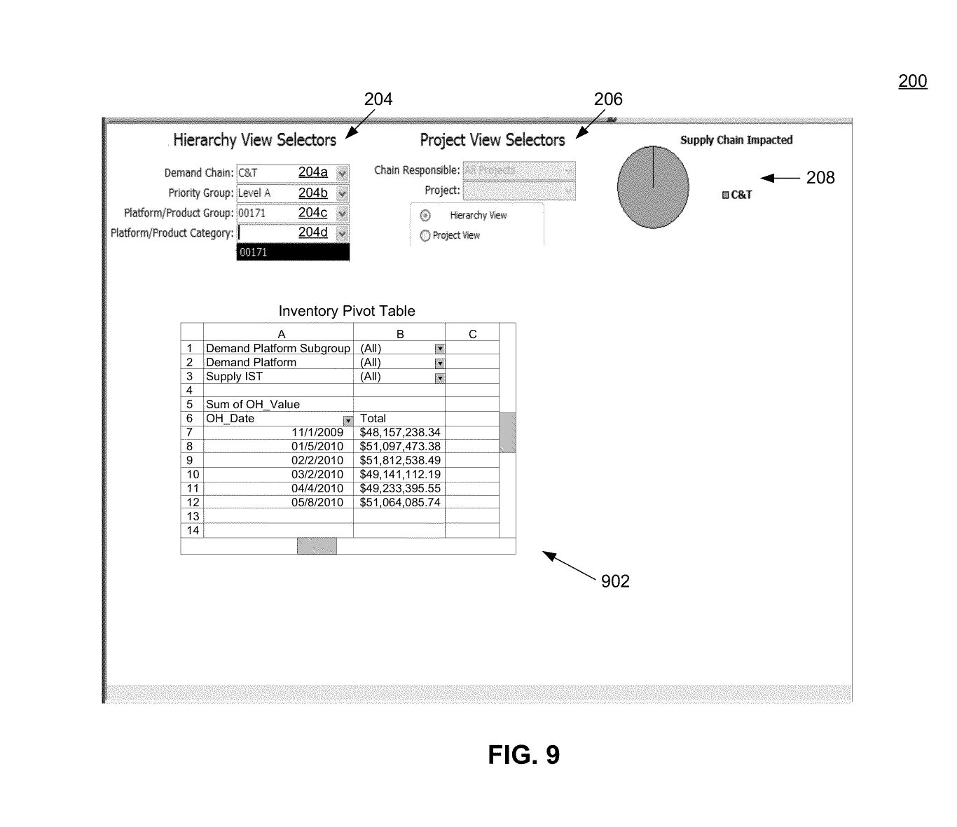

At operation 118 of FIG. 1, a determination may be made as to whether a third tier or level of the hierarchy has been selected (e.g., of 204c of FIG. 9) within the sales and operations planning user interface tool (e.g., 200). Note that if not, the method 100 may proceed to repeat operation 118. However, if it is determined at operation 118 that a third tier or level has been selected within the sales and operations planning user interface tool, the method 100 may proceed to operation 120. FIG. 9 shows still another exemplary view of the S&OP user interface tool 200 in accordance with various embodiments of the invention. It is noted that operation 118 may be implemented in a wide variety of ways. For example in one embodiment, the S&OP user interface tool 200 of FIG. 9 may be implemented with a drop-down menu 204c which may be utilized by a user to select a particular third tier or level (e.g., platform/product group) from one or more available third tiers or levels (e.g., platform/product groups) of the S&OP user interface tool 200. Within the present embodiment of FIG. 9, the drop-down menu 204c was utilized to select the “00171” platform/product group. It is pointed out that the S&OP user interface tool 200 of FIG. 9 illustrates a selection of the “C&T” demand chain hierarchy at drop-down menu 204a, a selection of the “Level A” priority group hierarchy at drop-down menu 204b. As such, the selection of the “00171” platform/product group hierarchy at drop-down menu 204c is associated with the other current hierarchy selections at drop-down menus 204a and 204b. Operation 118 may be implemented in any manner similar to that described herein, but is not limited to such.

At operation 120, one or more spreadsheet pivot tables may be automatically generated corresponding to the selected third tier (e.g., 204c). Note that operation 120 may be implemented in a wide variety of ways. For example in an embodiment, the S&OP user interface tool 200 of FIG. 9 may be implemented to automatically generate one or more spreadsheet pivot tables corresponding to the selected “00171” platform/product group hierarchy of 204c. For instance, the one or more spreadsheet pivot tables at operation 120 may include any type of pivot table that may be generated from any of the data and/or information described herein, but is not limited to such. Operation 120 may be implemented in any manner similar to that described herein, but is not limited to such.

At operation 122 of FIG. 1, the one or more generated spreadsheet pivot tables corresponding to the selected third tier (e.g., of 204c) may be output for display as part of the sales and operations planning user interface tool (e.g., 200). For example in the present embodiment of FIG. 9, the S&OP user interface tool 200 may include, but is not limited to, a graphical representation of an inventory spreadsheet pivot table 902 which corresponds with the selected “00171” platform/product group of 204c.

At operation 124, a determination may be made as to whether a fourth tier or level of the hierarchy has been selected (e.g., at 204d) within the sales and operations planning user interface tool (e.g., 200). If not, the method 100 may proceed to repeat operation 124. However, if it is determined at operation 124 that a fourth level has been selected within the sales and operations planning user interface tool, the method may proceed to operation 126. It is noted that operation 124 may be implemented in a wide variety of ways. For example in one embodiment, the S&OP user interface tool 200 of FIG. 9 may be implemented with a drop-down menu 204d which may be utilized by a user to select a particular fourth level of the hierarchy (e.g., platform/product category) from one or more available fourth levels (e.g., platform/product categories) of the S&OP user interface tool 200. Within the present embodiment of FIG. 9, the drop-down menu 204d is currently being utilized to select the “00171” platform/product category hierarchy. Operation 124 may be implemented in any manner similar to that described herein, but is not limited to such.

At operation 126 of FIG. 1, one or more metrics may automatically be determined or aggregated corresponding to the selected fourth level (e.g., at 204d). Note that operation 126 may be implemented in a wide variety of ways. For example in an embodiment, the S&OP user interface tool 200 of FIG. 9 may be implemented to automatically determine or aggregate one or more metrics corresponding to the selected “00171” platform/product category at 204d. For instance, the one or more metrics at operation 126 may include any of the metrics described or mentioned herein, but are not limited to such. It is pointed out that operation 126 may be implemented in any manner similar to that described herein, but is not limited to such.

At operation 128, the one or more determined or aggregated metrics corresponding to the selected fourth tier (e.g., at 204d) may be output for display as part of the sales and operations planning user interface tool (e.g., 200). For example in various embodiments, the S&OP user interface tool 200 may include a graphical representation of the one or more determined or aggregated metrics corresponding to the selected fourth level (e.g., at 204d) in any manner similar to that described herein, but are not limited to such. In one embodiment, once operation 128 is completed, the method 100 may be ended. In an embodiment, once operation 128 is completed, the method 100 may proceed to any of its operations. In this manner, a sales and operations planning interface tool may be generated and operated in accordance with various embodiments of the invention.

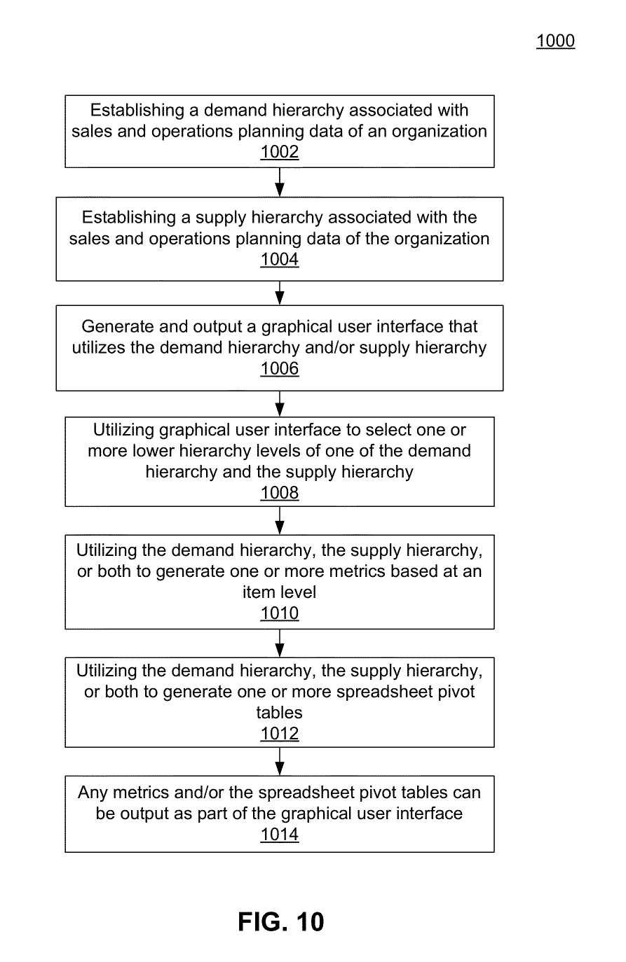

FIG. 10 shows an exemplary flow diagram of a method 1000 in accordance with various embodiments of the invention for generating and operating a sales and operations planning interface tool. Although specific operations are disclosed in flow diagram 1000, such operations are examples. Method 1000 may not include all of the operations illustrated by FIG. 10. Also, method 1000 may include various other operations and/or variations of the operations shown by FIG. 10. Likewise, the sequence of the operations of flow diagram 1000 may be modified. It is appreciated that not all of the operations in flow diagram 1000 may be performed. In various embodiments, one or more of the operations of method 1000 may be performed by software, by firmware, by hardware or by any combination thereof, but is not limited to such. Method 1000 may include processes of embodiments of the invention which may be carried out by a processor(s) and electrical components under the control of computer or computing device readable and executable instructions (or code). The computer or computing device readable and executable instructions (or code) may reside, for example, in data storage features such as computer or computing device usable volatile memory, computer or computing device usable non-volatile memory, and/or computer or computing device usable mass data storage. However, the computer or computing device readable and executable instructions (or code) may reside in any type of computer or computing device readable medium.

Method 1000 may include establishing a demand hierarchy associated with sales and operations planning data of an organization. In addition, a supply hierarchy may be established that is associated with the sales and operations planning data of the organization. A graphical user interface may be generated and output that utilizes the demand hierarchy and/or supply hierarchy. The graphical user interface may be utilized to select one or more lower hierarchy levels of one of the demand hierarchy and the supply hierarchy. One or more metrics based at an item level may be generated utilizing the demand hierarchy, the supply hierarchy, or both the demand and supply hierarchies. One or more spreadsheet pivot tables may be generated utilizing the demand hierarchy, the supply hierarchy, or both the demand and supply hierarchies. The one or more metrics and/or the one or more spreadsheet pivot tables may be output as part of the graphical user interface. In this manner, a sales and operations planning interface tool may be generated and operated in accordance with various embodiments of the invention.

At operation 1002 of FIG. 10, a demand hierarchy (e.g., 300 of FIG. 3) may be established that is associated with sales and operations planning data of an organization (e.g., business, government, and the like). It is pointed out that operation 1002 may be implemented in a wide variety of ways. For example in various embodiments, operation 1002 may be implemented in any manner similar to that described herein, but is not limited to such.

At operation 1004, a supply hierarchy (e.g., 320 of FIG. 3) may be established that is associated with the sales and operations planning data of the organization (e.g., business, government, and the like). It is noted that operation 1004 may be implemented in a wide variety of ways. For example in various embodiments, operation 1004 may be implemented in any manner similar to that described herein, but is not limited to such.

At operation 1006 of FIG. 10, a graphical user interface (e.g., 200) may be generated and output that utilizes the demand hierarchy and/or supply hierarchy. Note that operation 1006 may be implemented in a wide variety of ways. For example in various embodiments, operation 1006 may be implemented in any manner similar to that described herein, but is not limited to such.

At operation 1008, the graphical user interface (e.g., 200) may be utilized to select one or more lower hierarchy levels (e.g., 204a, 204b, 204c, and/or 204d) of one of the demand hierarchy and the supply hierarchy. It is pointed out that operation 1008 may be implemented in a wide variety of ways. For example in various embodiments, operation 1008 may be implemented in any manner similar to that described herein, but is not limited to such.

At operation 1010 of FIG. 10, one or more metrics based at an item level may be generated (e.g., 108, 114, 124, and the like) utilizing the demand hierarchy, the supply hierarchy, or both the demand and supply hierarchies. It is noted that operation 1010 may be implemented in a wide variety of ways. For example in various embodiments, operation 1010 may be implemented in any manner similar to that described herein, but is not limited to such.

At operation 1012, one or more spreadsheet pivot tables may be generated (e.g., 120) utilizing the demand hierarchy, the supply hierarchy, or both the demand and supply hierarchies. Note that operation 1012 may be implemented in a wide variety of ways. For example in various embodiments, operation 1012 may be implemented in any manner similar to that described herein, but is not limited to such.

At operation 1014 of FIG. 10, the one or more metrics (e.g., 212, 214, 216, 218, 220, 404, 406, 408, 410, 412, and the like) and/or the one or more spreadsheet pivot tables (e.g., 902) may be output as part of the graphical user interface (e.g., 200). It is pointed out that operation 1014 may be implemented in a wide variety of ways. For example in one embodiment, a graphical representation of the one or more metrics and/or the one or more spreadsheet pivot tables may be output at operation 1014 as part of the graphical user interface. Operation 1014 may be implemented in any manner similar to that described herein, but is not limited to such. In this manner, a sales and operations planning interface tool may be generated and operated in accordance with various embodiments of the invention.

Note that the S&OP user interface tool (e.g., 200) may be implemented in a wide variety of ways. In addition, demand and supply hierarchies provide the way for the top to organize and generate and/or aggregate all the different performance metrics (e.g., Backorders, Forecast Accuracy, Production Plan, Purchase Requisition Workload, etc). The tool uses four tiers to the hierarchy that can be based on whatever is important to the organization. For example, weapon system and weapon system subgroups can be used on the demand side and supply divisions (e.g., logical item groupings—bearings, fasteners, etc) and subdivisions on the supply side.

Management Tool (GUI 200)—view the business's performance metrics based on the hierarchies at an aggregate level to make decisions and push high level goals down to the lowest tiers of the hierarchy.

Actionable Tool (Pivot Table) of the tool 200—may used by the “doers” in the organization or business so that they can drill down into the lowest level of data in order to target actions. Drill down available for all metrics show in the GUI.

Forward-looking metrics:

Budget management—project financial plans based on when purchase requisitions will likely be awarded;

Resource management—allocate buyers in order to best meet required purchase requisition awards;

Forecast management—baseline forecasts and track to them over the course of the year.

Provides organizational direction:

By pushing performance metrics down to the lowest level and tracking them over time, management can better direct actions of the organization and monitor results to help ensure the organization moves in the direction that leadership wishes it to go.

Other names in accordance with an embodiment:

### Chain: Demand Chain (Demand), Supply Chain(Supply)

### Priority Group: Demand Division (Demand), Supply Directorate (Supply)

### Group: Demand Platform (Demand), Supply Division (Supply)

### Category: Demand Platform Subgroup (Demand), Supply IST (Supply)

Note that various metrics can be used with the S&OP user interface 200. For example, the following list includes, but is not limited to, exemplary metrics that can be used with the S&OP user interface 200 and how each is generated by a computing device (e.g., one or more modules operating on the computer device):

Consensus forecast:—Fiscal Year Cumulative Projections and actual results for forecasts and demand. Also contains an original projection that is held constant.

Consensus organization fund budget:—Fiscal Year Cumulative Projections of money that has been and will be allocated. Also contains and original projection that is held constant.

Attainment to Plan (ATP): Whether a purchase requisition is delivered from the supplier as planned.

Absolute Percent Forecast Error (APFE): Ifcst money—demand money)/demand money.

POF/OTOF: Have customer orders been filled on time. POF measures from order until customer receipt, OTOF measures from order until shipment.

Consensus OA (Obligation Authority) budget metric: same as fund budget.

Total overhead (OH) inventory: On Hand Inventory—how much inventory is being held.

Percent Forecast Error (PFE): see APFE.

Demand consensus: see consensus forecast.

Demand ratio: next 12 months of forecast/last 12 months of demand.

DPA

Production plan (which can include allocation of purchase requisition capacity): when PRs (purchase requisitions) will likely be awarded. As an overview, it racks and stacks on hand and projected PRs and applies a prioritization along with demonstrated award capacity to determine which PRs will be awarded and when.

Blocked purchase requisitions: the value of the blocked requisitions.

Stock Out/Stock Low (SO/SL): items with projected stock outs and low (penetrate safety stock) during the lead time of the item. In one embodiment, it is not calculated by the user interface, the user interface shows the metric.

Over procurements (OPs): in an embodiment, not calculated by the user interface, the user interface shows the metric.

Current inventory levels: see OH.

Late purchase requisitions (PRs): shows late PRs—if the award comes in 2 weeks after the required award date, the PR is late. The lateness category can be broken out by days.

Late purchase orders (POs): shows late POs—if the delivery comes in, for example, 2 weeks after scheduled date, the PO is late. The lateness category may be broken out by days in one embodiment.

Open/blocked purchase requisitions: see open and blocked.

Supportability: this report takes the SO/SL and applies the Production Plan to it to determine more accurate get well dates for items.

Open purchase requisition (PR) value metric: the value of open requisitions.

Unfilled Order (UFO) indicator metric: money value of backorders.

Delivered purchase order (PO) lines metric: whether PO lines were delivered on time. This is a yes/no metric.

Vendor scorecard metric.

The foregoing descriptions of various specific embodiments in accordance with the invention have been presented for purposes of illustration and description. They are not intended to be exhaustive or to limit the invention to the precise forms disclosed, and many modifications and variations are possible in light of the above teaching. The invention is to be construed according to the Claims and their equivalents.

What is claimed is:

1. A method comprising:
establishing a demand hierarchy associated with sales and operations planning data of an organization, wherein any item of said demand hierarchy is not assigned to another hierarchy group;
establishing a supply hierarchy associated with said sales and operations planning data of said organization, wherein any item of said supply hierarchy is not assigned to another hierarchy group; and
utilizing one of said demand hierarchy and said supply hierarchy to generate a metric based at an item level; and
outputting said metric as part of a graphical user interface.

2. The method of claim 1, further comprising:
utilizing one of said demand hierarchy and said supply hierarchy to generate a spreadsheet pivot table.

3. The method of claim 1, wherein said metric comprises comparing demand over a past time period to a forecast of a future time period.

4. The method of claim 3, wherein said past time period is last 12 months and said future time period is next 12 months.

5. The method of claim 1, wherein said metric comprises a production plan metric comprising workload capacity.

6. The method of claim 5, wherein said production plan further comprising projecting when a purchase requisition will be awarded.

7. The method of claim 1, further comprising:
utilizing said graphical user interface to select a lower hierarchy level of one of said demand hierarchy and said supply hierarchy.

8. The method of claim 7, further comprising:
after utilizing said graphical user interface to select a lower hierarchy level, outputting a graphical representation of said metric as part of said graphical user interface.

9. A computer readable storage medium having stored thereon, computer-executable instructions that when executed by a computing device cause the computing device to perform a method comprising:
establishing a demand hierarchy associated with sales and operations planning data of an organization, wherein any item of said demand hierarchy is not assigned to another hierarchy group;
establishing a supply hierarchy associated with said sales and operations planning data of said organization, wherein any item of said supply hierarchy is not assigned to another hierarchy group; and
utilizing one of said demand hierarchy and said supply hierarchy to generate a spreadsheet pivot table; and
outputting said spreadsheet pivot table as part of a graphical user interface.

10. The computer readable storage medium of claim 9, further comprising:
utilizing one of said demand hierarchy and said supply hierarchy to generate a metric based at an item level.

11. The computer readable storage medium of claim 10, wherein said metric comprises comparing demand over a past time period to a forecast of a future time period.

12. The computer readable storage medium of claim 11, wherein said past time period is last year and said future time period is next year.

13. The computer readable storage medium of claim 10, wherein said metric comprises a production plan metric that comprises projecting when a purchase requisition will be awarded.

14. The computer readable storage medium of claim 9, further comprising:
utilizing said graphical user interface to select a lower hierarchy level of one of said demand hierarchy and said supply hierarchy.

15. The computer readable storage medium of claim 14, further comprising:
after utilizing said graphical user interface to select a lower hierarchy level, outputting a graphical representation of said spreadsheet pivot table as part of said graphical user interface.

16. A method comprising:
establishing a demand hierarchy associated with sales and operations planning data of an organization, wherein said demand hierarchy is set at an item level and any item of said demand hierarchy is not assigned to another hierarchy group;
establishing a supply hierarchy associated with said sales and operations planning data of said organization, wherein said supply hierarchy is set at an item level and any item of said supply hierarchy is not assigned to another hierarchy group; and
utilizing one of said demand hierarchy and said supply hierarchy to generate a metric based at an item level; and
outputting a graphical representation of said metric as part of a graphical user interface.

17. The method of claim 16, further comprising:
utilizing one of said demand hierarchy and said supply hierarchy to generate a spreadsheet pivot table.

18. The method of claim 16, wherein said metric comprises comparing demand over a past time period to a forecast of a future time period.

19. The method of claim 16, wherein said metric comprises a production plan metric that comprises projecting when a purchase requisition will be awarded.

20. The method of claim 1, further comprising:
utilizing said graphical user interface to select a lower hierarchy level of one of said demand hierarchy and said supply hierarchy.
